(19) United States
(12) Patent Application Publication
(10) Pub. No.: US 2008/0236421 A1
(43) Pub. Date: Oct. 2, 2008

(54) Liquid transfer apparatus

(75) Inventor: Reiji Ito, Ibaraki (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Komori Corporation

(21) Appl. No.: 12/079,634

(22) Filed: Mar. 27, 2008

(30) Foreign Application Priority Data
Mar. 28, 2007 (JP) 084812/2007

(51) Int. Cl. B41F 7/02

(52) U.S. Cl. 101/217

(57) ABSTRACT

A liquid transfer apparatus includes a supply cylinder and viscosity reducing agent supply unit. The supply cylinder comes into contact with a transfer target body and performs transfer by transferring a transfer liquid to the transfer target body. The viscosity reducing agent supply unit supplies a viscosity reducing agent which reduces a viscosity of the transfer liquid to the supply cylinder during transfer.

### BACKGROUND OF THE INVENTION

The present invention relates to a liquid transfer apparatus which performs transfer (coating/printing) by supplying a transfer liquid (varnish/ink) to a transfer target body (sheet/web).

In general, a liquid transfer apparatus comprises a first blanket cylinder to which a varnish supply device supplies varnish, a second blanket cylinder which opposes the first blanket cylinder, a varnish supply cylinder which opposes the second blanket cylinder and transfers the varnish to it, and a liquid supply device which supplies to an impression cylinder and the varnish supply cylinder a varnish anti-drying liquid to prevent the varnish from drying. In this arrangement, as a sheet/web passes between the first and second blanket cylinders, the two surfaces of the sheet/web are coated with the varnish.

In a conventional liquid transfer apparatus, as disclosed in Japanese Patent Laid-Open No. 2006-56055, a varnish anti-drying liquid is supplied to an impression cylinder and varnish supply cylinder immediately after the start of coating and at the end of coating when the amount of varnish transferred to the impression cylinder and varnish supply cylinder becomes unstable and insufficient. This prevents the varnish from drying, so the sheet/web will not stick to the blankets of the first and second blanket cylinders.

In the conventional liquid transfer apparatus (coating apparatus) described above, when the operation time of the printing press is long, the viscosity of the varnish transferred to the surface of the blanket cylinder during coating increases as the time passes. In addition, some of the varnish remaining on the blanket cylinder without being transferred to a sheet accumulates on the surface of the blanket cylinder. In this situation, since the adhesive force of the varnish on the blanket cylinder increases, a sheet/web sticks to the blanket cylinder, and therefore much load and time are required to remove it from the blanket cylinder. Furthermore, since the sheet adhering to the first blanket cylinder, which opposes the second blanket cylinder, is pulled up, nonuniformity occurs in the varnish on the reverse of the sheet, i.e., on the second blanket cylinder side. These problems also occur in a printing apparatus which prints using a liquid having a high viscosity like varnish, e.g., high-viscosity ink.

### SUMMARY OF THE INVENTION

It is an object of the present invention to provide a liquid transfer apparatus which prevents the viscosity of a liquid on a supply cylinder from increasing during transfer.

In order to achieve the above object, according to the present invention, there is provided a liquid transfer apparatus comprising a supply cylinder which comes into contact with a transfer target body and performs transfer by transferring a transfer liquid to the transfer target body, and viscosity reducing agent supply means for supplying a viscosity reducing agent which reduces a viscosity of the transfer liquid to the supply cylinder during transfer.

### BRIEF DESCRIPTION OF THE DRAWINGS

FIG. 1 is a side view showing a sheet-fed rotary printing press as a whole;

FIG. 2 is a side view of a coating apparatus to which a liquid transfer apparatus according to an embodiment of the present invention is applied;

FIG. 3 is a side view of the main part which describes a throw-on/off mechanism for an upper blanket cylinder shown in FIG. 2;

FIG. 4 is a view showing the arrangement of rollers in coating by the coating apparatus shown in FIG. 2;

FIG. 5 is a view showing the arrangement of the rollers at the end of coating by the coating apparatus shown in FIG. 2;

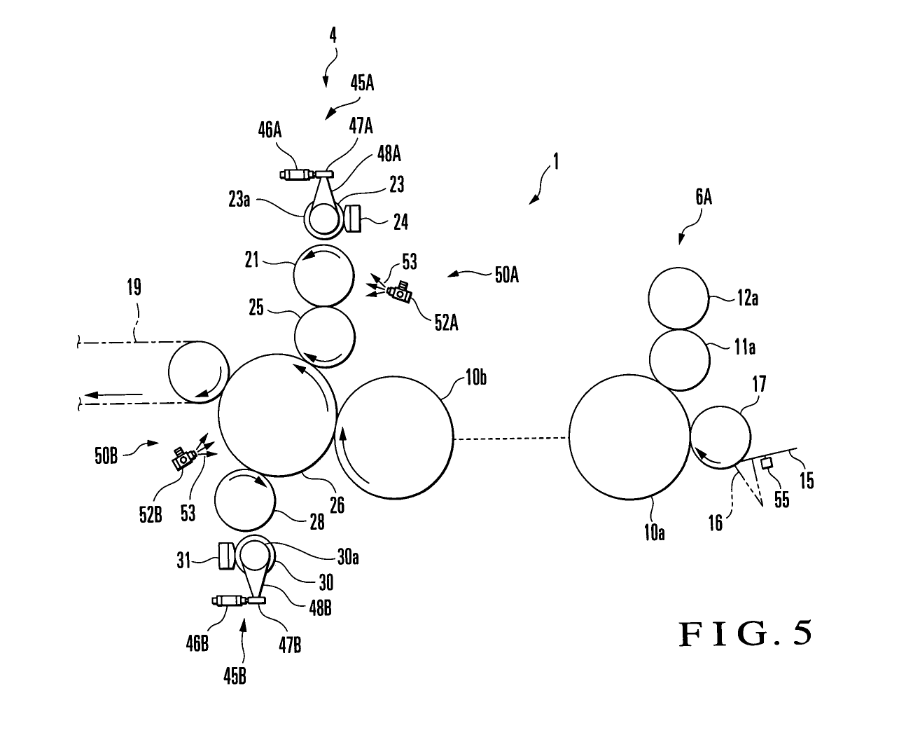

FIG. 6 is a view seen from the direction of an arrow VI in FIG. 2;

FIG. 7 is a block diagram showing the electrical configuration of the liquid transfer apparatus shown in FIG. 2;

FIG. 8 is a flowchart to explain the coating operation of the liquid transfer apparatus shown in FIG. 7;

FIG. 9 is a flowchart to explain upper spray control (pre-coating) shown in FIG. 8;

FIG. 10 is a flowchart to explain lower spray control (pre-coating) shown in FIG. 8;

FIG. 11 is a flowchart to explain an impression throw-on operation shown in FIG. 8;

FIG. 12 is a flowchart to explain upper spray control (during coating) shown in FIG. 8;

FIG. 13 is a flowchart to explain lower spray control (during coating) shown in FIG. 8;

FIG. 14 is a flowchart to explain upper spray control (post-coating) shown in FIG. 8;

FIG. 15 is a flowchart to explain lower spray control (post-coating) shown in FIG. 8; and

FIG. 16 is a flowchart to explain an impression throw-off operation shown in FIG. 8.

### DESCRIPTION OF THE PREFERRED EMBODIMENT

A liquid transfer apparatus according to an embodiment of the present invention will be described in detail with reference to the accompanying drawings.

### [Sheet-Fed Rotary Printing Press]

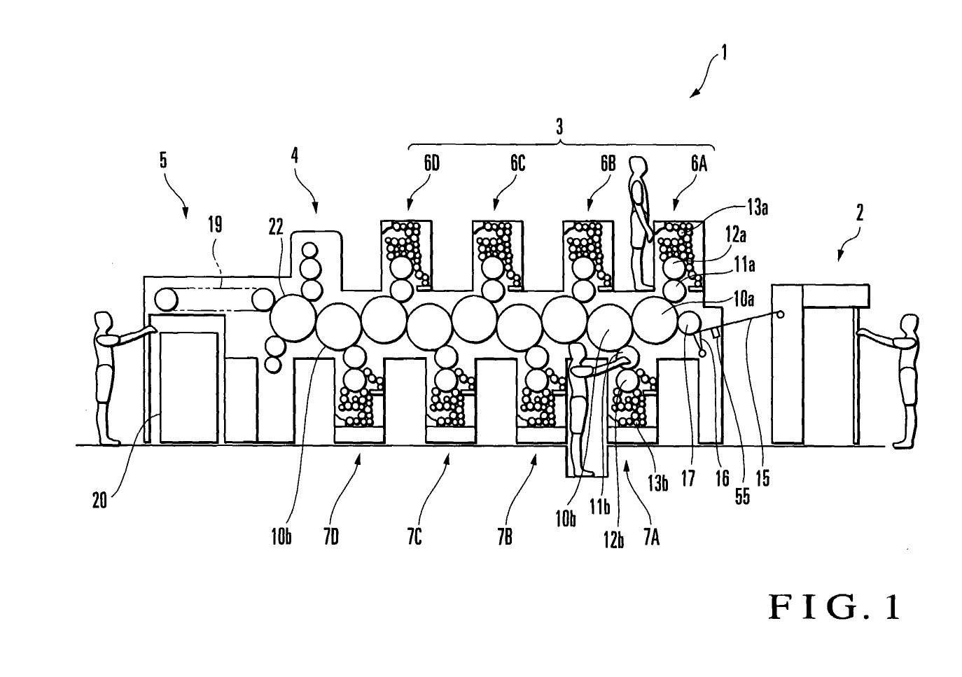

As shown in FIG. 1, a sheet-fed rotary printing press 1 comprises a feeder 2 which feeds a sheet (transfer target body), a printing unit 3 which prints the sheet fed from the feeder 2, a coating unit 4 which coats the obverse and reverse of the sheet printed by the printing unit 3 with varnish, and a delivery unit 5 to which the sheet coated by the coating unit 4 is delivered. The printing unit 3 comprises first to fourth obverse printing units 6A to 6D and first to fourth reverse printing units 7A to 7D. The sheet-fed rotary printing press 1 serves as a liquid transfer machine. The feeder 2 serves as a supply unit. The printing unit 3 and coating unit 4 serve as a liquid transfer unit. The delivery unit 5 serves as a discharge unit.

Each of the four obverse printing units 6A to 6D comprises an impression cylinder 10a having a gripper unit in its circumferential surface to grip a sheet, a blanket cylinder 11a opposing the upper portion of the impression cylinder 10a, a plate cylinder 12a opposing the upper portion of the blanket cylinder 11a, and an ink supply unit 13a which supplies ink to the plate cylinder 12a. The impression cylinder 10a comprises a double-diameter cylinder having a diameter twice that of the plate cylinder 12a. The gripper unit serves as a holding unit. The impression cylinder 10a serves as a transport cylinder. The blanket cylinder 11a serves as a printing cylinder and a supply cylinder which supplies ink.

Each of the four reverse printing units 7A to 7D comprises an impression cylinder 10b having a gripper unit in its circumferential surface to grip a sheet, a blanket cylinder 11b opposing the lower portion of the impression cylinder 10b, a plate cylinder 12b opposing the lower portion of the blanket cylinder 11b, and an ink supply unit 13b which supplies the ink to the plate cylinder 12b. The impression cylinder 10b comprises a double-diameter cylinder having a diameter twice that of the plate cylinder 12b. The gripper unit serves as a holding unit. The impression cylinder 10b serves as a transport cylinder. The blanket cylinder 11b serves as a printing cylinder and a supply cylinder which supplies ink.

In this arrangement, the leading edge of a sheet fed from the feeder 2 onto a feeder board 15 is gripped by a swing arm shaft pregripper 16 and then gripping-changed to the gripper of a transfer cylinder 17. The sheet gripping-changed to the gripper of the transfer cylinder 17 is gripping-changed to the gripper of the impression cylinder 10a of the obverse printing unit 6A and printed with the first color on its obverse as the sheet passes through the opposing point (nip) of the impression cylinder 10a and blanket cylinder 11a. Then, the sheet printed with the first color on the obverse is gripping-changed to the impression cylinder 10b of the reverse printing unit 7A and printed with the first color on its reverse as the sheet passes through the opposing point of the impression cylinder 10b and blanket cylinder 11b.

Subsequently, the sheet which is sequentially printed with the respective colors on each of its obverse and reverse by the obverse printing units 6B to 6D and reverse printing units 7B to 7D is coated with varnish on the obverse and reverse by the coating unit 4. The coated sheet is gripping-changed to the delivery gripper (not shown) of a delivery chain 19 of the delivery unit 5 and conveyed by the delivery chain 19. The sheet conveyed by the delivery chain 19 serving as a delivery means is dropped onto a delivery pile 20 and stacked there.

### [Coating Unit]

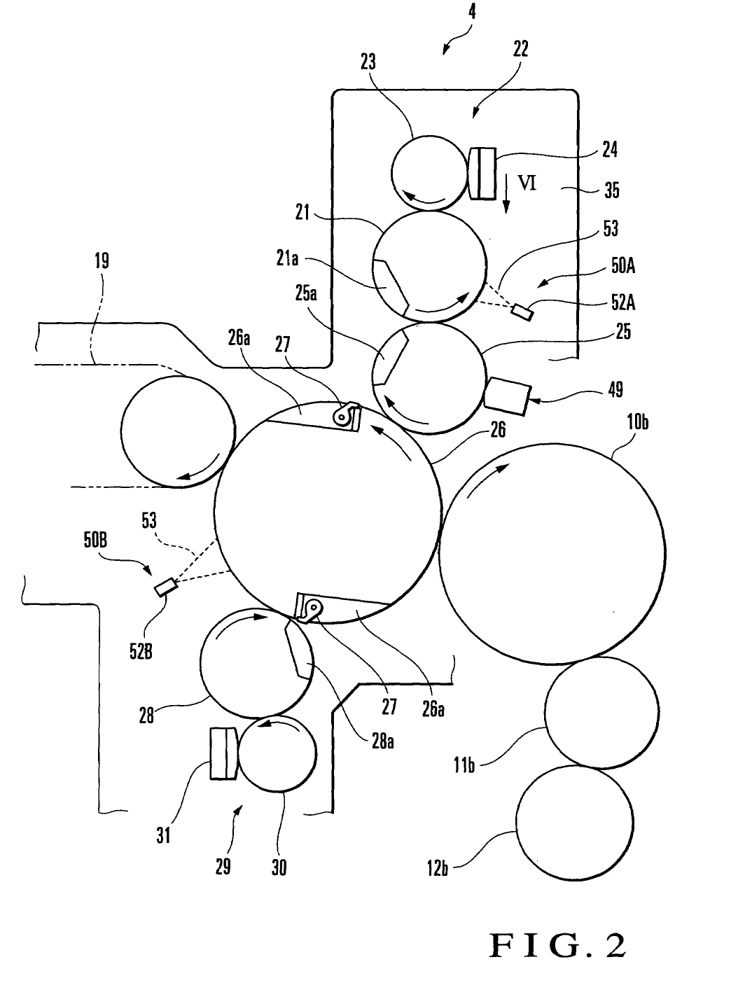

The coating unit 4 will be described with reference to FIG. 2. As shown in FIG. 2, an upper plate cylinder 21 (first cylinder) has a notch 21a extending in the axial direction in part of its circumferential surface. A varnish supply device 22 (first liquid supply means) which supplies the varnish to the upper plate cylinder 21 comprises an anilox roller 23 which is arranged to oppose the upper plate cylinder 21 and a chamber coater 24 which supplies the varnish to the anilox roller 23. An upper blanket cylinder 25 (second cylinder) arranged to oppose the upper plate cylinder 21 and a blanket cylinder 26 (third cylinder) has a notch 25a extending in the axial direction in part of its circumferential surface. The blanket cylinder 26 and upper blanket cylinder 25 serve as a supply cylinder which supplies varnish.

The blanket cylinder 26 has notches 26a extending in the axial direction at positions that halve the circumferential surface in the circumferential direction. Each notch 26a is provided with a gripper unit 27 (sheet holding means) having a gripper pad and gripper which grip and convey the sheet. A lower plate cylinder 28 arranged to oppose the blanket cylinder 26 has a notch 28a extending in the axial direction in part of its circumferential surface. A varnish supply device 29 (second liquid supply means) which supplies the varnish to the lower plate cylinder 28 comprises an anilox roller 30 arranged to oppose the lower plate cylinder 28, and a chamber coater 31 which supplies the varnish to the anilox roller 30.

The blanket cylinder 26 is arranged to oppose the impression cylinder 10b of the reverse printing unit 7D which serves as the most-downstream transport cylinder of the printing unit 3 in the sheet convey direction. The upper blanket cylinder 25 and blanket cylinder 26 are arranged to oppose each other in the downstream sheet convey direction from a position where the impression cylinder 10b of the reverse printing unit 7D opposes the blanket cylinder 26. The lower plate cylinder 28 and blanket cylinder 26 are arranged to oppose each other in the upstream sheet convey direction from a position where the impression cylinder 10b of the reverse printing unit 7D opposes the blanket cylinder 26.

In this arrangement, the varnish supplied from the chamber coater 24 to the anilox roller 23 is transferred to the upper blanket cylinder 25 through the upper plate cylinder 21. When the printed sheet passes through the opposing point of the upper blanket cylinder 25 and blanket cylinder 26, its obverse (one surface) is coated. Simultaneously, the varnish transferred from the lower plate cylinder 28 to the circumferential surface of the blanket cylinder 26 by the printing pressure of the upper blanket cylinder 25 coats the reverse (the other surface) of the printed sheet.

### [Blanket Cylinder Throw-On/Off Mechanism]

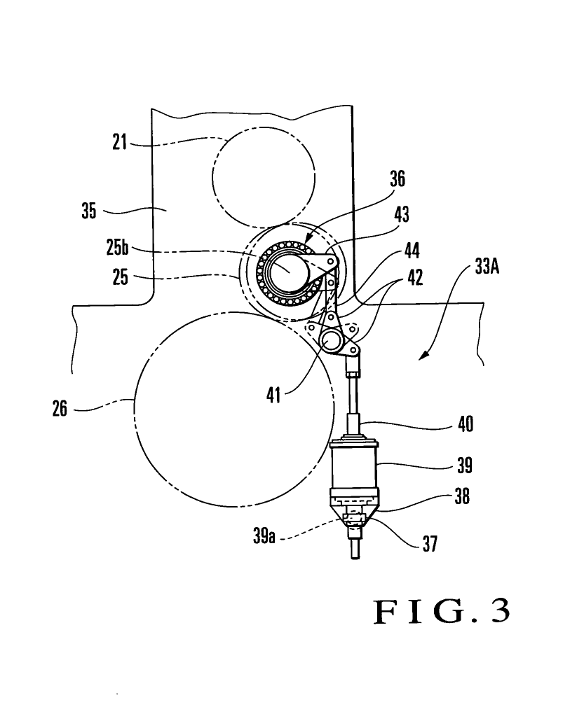

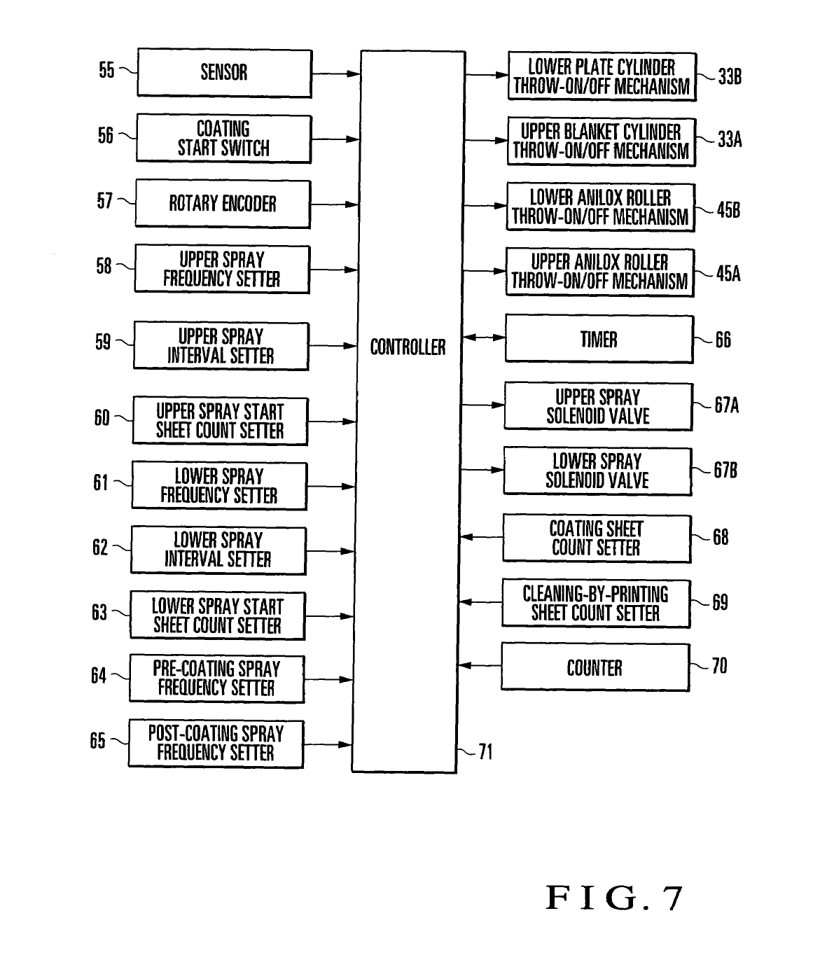

Two cylinder throw-on/off mechanisms which throw on/off the upper blanket cylinder 25 and lower plate cylinder 28 will be described with reference to FIG. 3. As these cylinder throw-on/off mechanisms have the same structure, only an upper blanket cylinder throw-on/off mechanism 33A which engages/releases the upper blanket cylinder 25 will be described in detail. A lower plate cylinder throw-on/off mechanism 33B (FIG. 7) which throws on/off the lower plate cylinder 28 will be briefly described where necessary.

A pair of frames 35 arranged to oppose each other at a predetermined gap rotatably, axially support the two end shafts of each of the blanket cylinder 26 and upper plate cylinder 21 through bearings (not shown). Eccentric bearings 36 fitted on the pair of frames 35 rotatably, axially support two end shafts 25b of the upper blanket cylinder 25. A stud 37 projecting outward from one frame 35 near one end shaft of the blanket cylinder 26 supports a bracket 38. A stepping motor 39 serving as a driving device is attached to the bracket 38 with a driving rod 40 standing vertically.

When a nut 39a is driven by the stepping motor 39 to rotate, the driving rod 40 with a threaded portion threadably engaging with the nut 39a vertically moves. A connecting lever 42 having an L shape when seen from the front is axially mounted on the projecting portion of a lever shaft 41 which is located above the driving rod 40 and the two ends of which are axially supported by the pair of frames 35.

Each eccentric bearing 36 has an outer ring (not shown) fitted with a housing mounted in the bearing hole of the corresponding frame 35 through a needle roller and an inner ring (not shown) rotatably fitted in the outer ring through a tapered roller. A bearing lever 43 fixed to the outer ring of the eccentric bearing 36 is connected to the connecting lever 42 through a rod 44. When the driving rod 40 is driven by the stepping motor 39 to move forward/backward, the eccentric bearing 36 pivots through the connecting lever 42, rod 44, and bearing lever 43.

The axis of the inner circumferential surface of the inner ring that constitutes the eccentric bearing 36 is eccentric from that of the outer circumferential surface of the outer ring that constitutes the eccentric bearing 36 by a predetermined distance. Accordingly, in the thrown-on state of the upper blanket cylinder 25, when the rod 40 of the stepping motor 39 moves backward, the axis of the inner circumferential surface of the inner ring moves about the axis of the outer circumferential surface of the outer ring as the center. Accordingly, the upper blanket cylinder 25 is spaced apart from the blanket cylinder 26 and upper plate cylinder 21 to form a gap between the two cylinders 21 and 26, thus performing impression throw-off.

The eccentric bearing (not shown) of the lower plate cylinder 28 is provided with a similar mechanism which is driven by a stepping motor (not shown) to pivot the eccentric bearing. Accordingly, regarding the lower plate cylinder 28 as well, when the eccentric bearing pivots upon rotation of the stepping motor, the lower plate cylinder 28 is spaced apart from the blanket cylinder 26 to form a gap with respect to the blanket cylinder 26, thus performing impression throw-off.

### [Anilox Roller Throw-On/Off Mechanism]

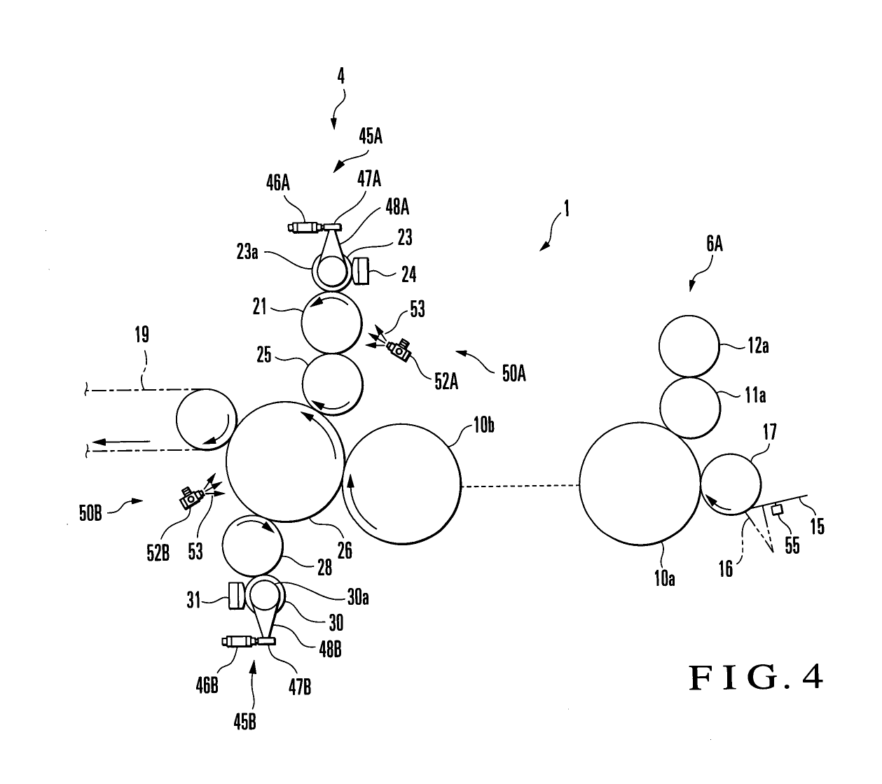

An upper anilox roller throw-on/off mechanism 45A which throws the anilox roller 23 which forms the varnish supply device 22 on/off the upper plate cylinder 21, and a lower anilox roller throw-on/off mechanism 45B which throws the anilox roller 30, forming the varnish supply device 29, on/off the lower plate cylinder 28 will be described with reference to FIG. 4. First, the upper anilox roller throw-on/off mechanism 45A will be described.

The anilox roller 23 is pivotally supported by the frames 35 through eccentric bearings 23a. The proximal end of a bearing lever 48A is fixed to the outer ring of the corresponding eccentric bearing 23a. The swing end of the bearing lever 48A is pivotally mounted on a rod 47A of an air cylinder 46A the cylinder end of which is pivotally mounted on the corresponding frame 35. In this arrangement, when the rod 47A of the air cylinder 46A moves forward/backward, the anilox roller 23 is thrown on/off the upper plate cylinder 21 through the bearing lever 48A.

The lower anilox roller throw-on/off mechanism 45B will be described. The anilox roller 30 is pivotally supported by the frames 35 through eccentric bearings 30a. The proximal end of a bearing lever 48B is fixed to the outer ring of the corresponding eccentric bearing 30a. The swing end of the bearing lever 48B is pivotally mounted on a rod 47B of an air cylinder 46B the cylinder end of which is pivotally mounted on the corresponding frame 35. In this arrangement, when the rod 47B of the air cylinder 46B moves forward/backward, the anilox roller 30 is thrown on/off the lower plate cylinder 28 through the bearing lever 48B.

As shown in FIG. 2, a cleaning apparatus 49 comprises a cleaning web which comes into contact with and separates from the circumferential surface of the upper blanket cylinder 25. The cleaning apparatus 49 wipes off varnish or contamination attached to the circumferential surface of the upper blanket cylinder 25 as the cleaning web comes into contact with the circumferential surface of the upper blanket cylinder 25.

### [Viscosity Reducing Agent Supply Means]

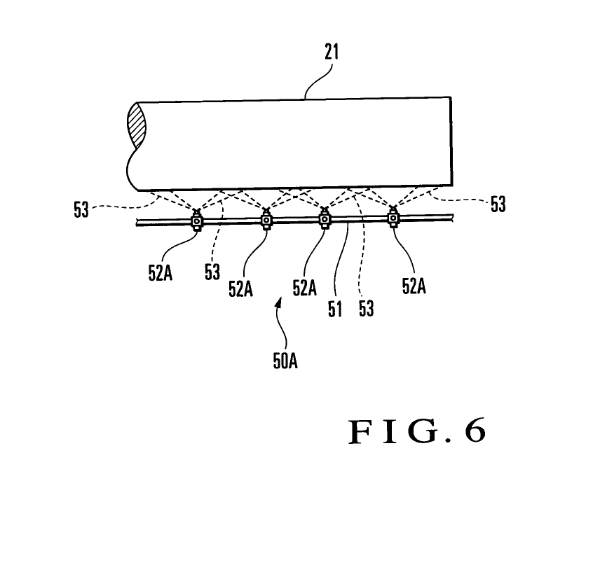

A first viscosity reducing agent supply device 50A which supplies a varnish viscosity reducing agent to the circumferential surface of the upper plate cylinder 21, and a second viscosity reducing agent supply device 50B which supplies the varnish viscosity reducing agent to the circumferential surface of the blanket cylinder 26 will be described with reference to FIGS. 2 and 6. As the two viscosity reducing agent supply devices 50A and 50B have the same structure, only the first viscosity reducing agent supply device 50A will be described, and the second viscosity reducing agent supply device 50B will be described where necessary.

As shown in FIG. 6, the first viscosity reducing agent supply device 50A comprises a pipe 51 horizontally extending between the pair of frames 35 such that its axial direction is parallel to that of the upper plate cylinder 21. The pipe 51 is provided with a plurality of upper sprays 52A to oppose each other throughout the entire axial direction of the upper plate cylinder 21. The upper sprays 52A selectively blow atomized water 53 serving as a varnish viscosity reducing agent to the circumferential surface of the upper plate cylinder 21.

The second viscosity reducing agent supply device 50B comprises a pipe horizontally extending between the pair of frames 35 such that its axial direction is parallel to that of the blanket cylinder 26. The pipe is provided with a plurality of lower sprays 52B to oppose each other throughout the entire axial direction of the blanket cylinder 26. The lower sprays 52B blow the atomized water 53 serving as the varnish viscosity reducing agent to the circumferential surface of the blanket cylinder 26.

### [Configuration of Present Invention]

The electrical configuration of the present invention will be described with reference to FIG. 7. The liquid transfer apparatus according to the present invention comprises, in addition to the upper blanket cylinder throw-on/off mechanism 33A, lower plate cylinder throw-on/off mechanism 33B, upper anilox roller throw-on/off mechanism 45A, and lower anilox roller throw-on/off mechanism 45B described above, a sensor 55, a coating start switch 56, a rotary encoder 57, an upper spray frequency setter 58, an upper spray interval setter 59, an upper spray start sheet count setter 60, a lower spray frequency setter 61, a lower spray interval setter 62, a lower spray start sheet count setter 63, a pre-coating spray frequency setter 64, a post-coating spray frequency setter 65, a timer 66, an upper spray solenoid valve 67A, a lower spray solenoid valve 67B, a coating sheet count setter 68, a cleaning-by-printing sheet count setter 69, a counter 70, and a controller 71 which is connected to the respective elements described above.

The sensor 55 (sheet supply detection means) detects that the feeder 2 has fed a sheet onto the feeder board 15. The coating start switch 56 instructs the coating unit 4 to start coating. The rotary encoder 57 (printing press phase detection means) detects the phase of the printing press. The spray frequency of the upper sprays 52A during coating/printing is set in the upper spray frequency setter 58 (supply frequency setting means). The upper spray frequency setter 58 serves as a supply amount setting means in which the amount of the varnish viscosity reducing agent 53 to be supplied from the upper sprays 52A is set. The spray interval of the upper sprays 52A during coating/printing is set in the upper spray interval setter 59 (supply interval setting means). The timing to start injection by the upper sprays 52A during coating/printing is set in the upper spray start sheet count setter 60 (supply start timing setting means) by using the sheet coating count or sheet printing count.

The spray frequency of the lower sprays 52B during coating/printing is set in the lower spray frequency setter 61 (supply frequency setting means). The lower spray frequency setter 61 serves as a supply amount setting means in which the amount of the varnish viscosity reducing agent 53 to be supplied from the lower sprays 52B is set. The spray interval of the lower sprays 52B during coating/printing is set in the lower spray interval setter 62 (supply interval setting means). The timing to start injection by the lower sprays 52B during coating/printing is set in the lower spray start sheet count setter 63 (supply start timing setting means) by using the coating sheet count or print sheet count.

The spray frequencies of the upper sprays 52A and lower sprays 52B, that is, the amounts of the varnish viscosity reducing agent 53 to be supplied from the upper sprays 52A and lower sprays 52B before coating are set in the pre-coating spray frequency setter 64 (pre-coating supply amount setting means). The spray frequencies of the upper sprays 52A and lower sprays 52B, that is, the amounts of the varnish viscosity reducing agent 53 to be supplied from the upper sprays 52A and lower sprays 52B after coating are set in the post-coating spray frequency setter 65 (post-coating supply amount setting means).

The timer 66 counts the intervals which are respectively set by the upper spray interval setter 59 and lower spray interval setter 62. The upper spray solenoid valve 67A (viscosity reducing agent supply means) is opened when supplying air to the upper sprays 52A. The lower spray solenoid valve 67B (viscosity reducing agent supply means) is opened when supplying air to the lower sprays 52B. The number of sheets to be coated by the coating unit 4 is set in the coating sheet count setter 68 (transfer sheet count setting means). The number of sheets for cleaning-by-printing for the varnish remaining on the cylinder after the last sheet is coated is set in the cleaning-by-printing sheet count setter 69. The counter 70 counts the number of sheets coated by the coating unit 4. The counter 70 may count the number of sheets fed from the feeder 2.

The controller 71 controls the opening/closing operation of the upper spray solenoid valve 67A and lower spray solenoid valve 67B until the injection frequencies of the upper sprays 52A and lower sprays 52B reach the spray injection frequency set in the pre-coating spray frequency setter 64. With this arrangement, the upper sprays 52A and lower sprays 52B blow and stop blowing the varnish viscosity reducing agent 53. The controller 71 controls the opening/closing operation of the upper spray solenoid valve 67A and lower spray solenoid valve 67B until the injection frequency of the upper sprays 52A and lower sprays 52B reaches the spray injection frequency set in the post-coating spray frequency setter 65. With this arrangement, the upper sprays 52A and lower sprays 52B blow and stop blowing the varnish viscosity reducing agent 53.

While the upper sprays 52A blow the varnish viscosity reducing agent 53 to the circumferential surface of the upper plate cylinder 21, when the rotary encoder 57 detects the phase of the cleaning liquid blowing range of the upper sprays 52A corresponding to the notch 21a of the upper plate cylinder 21, the controller 71 closes the upper spray solenoid valve 67A to stop blowing the varnish viscosity reducing agent 53 from the upper sprays 52A. Similarly, while the lower sprays 52B blow the varnish viscosity reducing agent 53 to the circumferential surface of the blanket cylinder 26, when the rotary encoder 57 detects the phase of the cleaning liquid blowing range of the lower sprays 52B corresponding to the notch 26a of the blanket cylinder 26, the controller 71 closes the lower spray solenoid valve 67B to stop blowing the varnish viscosity reducing agent 53 from the lower sprays 52B.

When the counter 70 counts the coating sheet count set by the coating sheet count setter 68, the controller 71 stops the coating operation, that is, the feed operation of the feeder 2. In throw-on of the upper blanket cylinder 25, when the notch 25a of the upper blanket cylinder 25 opposes the notch 21a of the upper plate cylinder 21, the controller 71 throws the upper blanket cylinder 25 on the upper plate cylinder 21 on the basis of the phase of the upper blanket cylinder 25 detected by the rotary encoder 57. Then, when the notch 25a of the upper blanket cylinder 25 opposes the notch 26a of the blanket cylinder 26, the controller 71 throws the upper blanket cylinder 25 on the blanket cylinder 26.

In throw-on of the lower plate cylinder 28, when the notch 28a of the lower plate cylinder 28 opposes the notch 26a of the blanket cylinder 26, the controller 71 throws the lower plate cylinder 28 on the blanket cylinder 26 on the basis of the phase of the lower plate cylinder 28 detected by the rotary encoder 57.

In throw-off of the upper blanket cylinder 25, when the notch 25a of the upper blanket cylinder 25 opposes the notch 21a of the upper plate cylinder 21, the controller 71 throws the upper blanket cylinder 25 off the upper plate cylinder 21 on the basis of the phase of the upper blanket cylinder 25 detected by the rotary encoder 57. Then, when the notch 25a of the upper blanket cylinder 25 opposes the notch 26a of the blanket cylinder 26 the controller 71 throws the upper blanket cylinder 25 off the blanket cylinder 26.

Also, in throw-off of the lower plate cylinder 28, when the notch 28a of the lower plate cylinder 28 opposes the notch 26a of the blanket cylinder 26, the controller 71 throws the lower plate cylinder 28 off the blanket cylinder 26 on the basis of the phase of the lower plate cylinder 28 detected by the rotary encoder 57.

When the counter 70 counts the sheet count set by the upper spray start sheet count setter 60 during the coating, the controller 71 opens the upper spray solenoid valve 67A to start blowing the varnish viscosity reducing agent 53 from the upper sprays 52A. Similarly, when the counter 70 counts the number of sheets set by the lower spray start sheet count setter 63 during the coating, the controller 71 opens the lower spray solenoid valve 67B to start blowing the varnish viscosity reducing agent 53 from the lower sprays 52B.

During the coating, the timer 66 counts the time elapsed after blowing the varnish viscosity reducing agent 53 from the upper sprays 52A, and when the elapsed time reaches the time set by the upper spray interval setter 59, the controller 71 starts blowing the varnish viscosity reducing agent 53 from the upper sprays 52A. Similarly, the timer 66 counts the time elapsed after blowing the varnish viscosity reducing agent 53 from the lower sprays 52B, during the coating, and when the elapsed time reaches the time set by the lower spray interval setter 62, the controller 71 starts blowing the varnish viscosity reducing agent 53 from the lower sprays 52B.

### [Coating Operation]

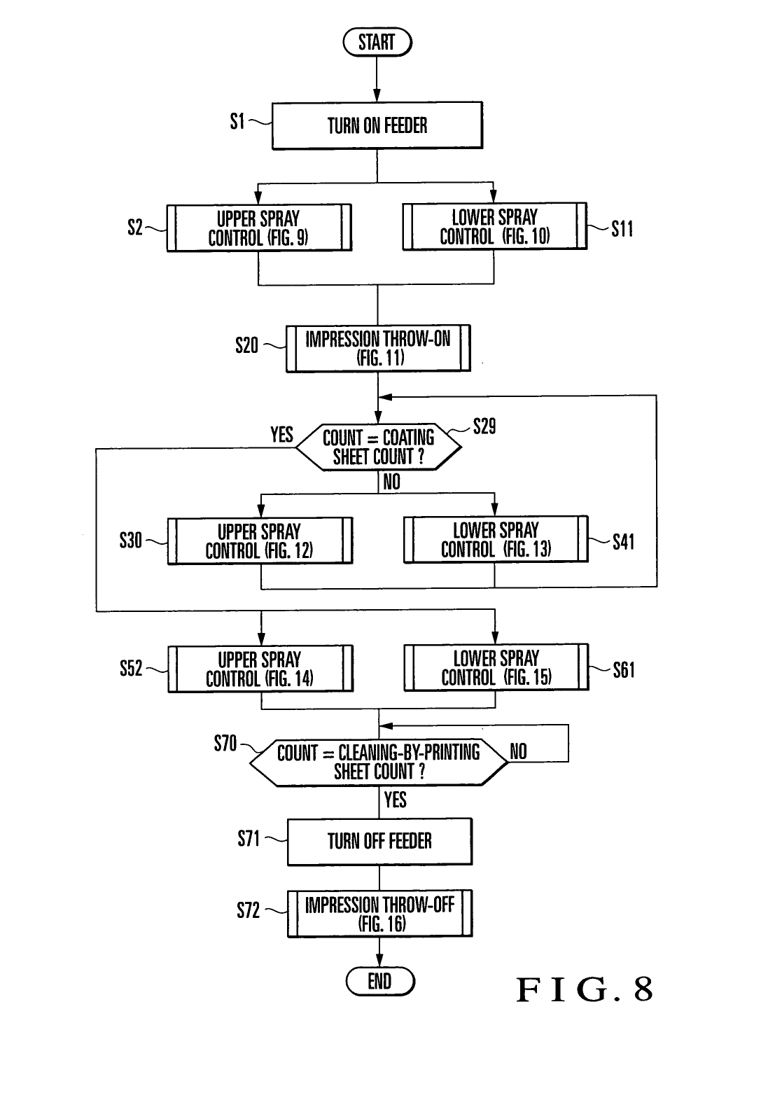

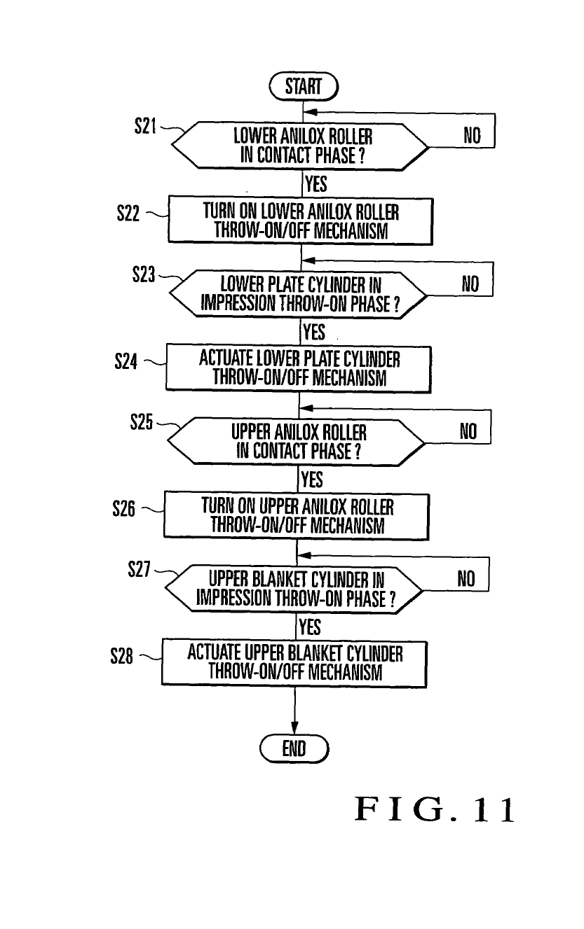

The coating operation of the coating apparatus having the above apparatus will be described with reference to FIGS. 8 to 16. First, a preparation operation before coating will be described with reference to FIGS. 8 to 11.

### [Normal Coating]

When the coating start switch 56 is manipulated, the feeder 2 starts feeding the sheet onto the feeder board 15 (step S1 in FIG. 8).

### [Upper Spray Control (Pre-Coating)]

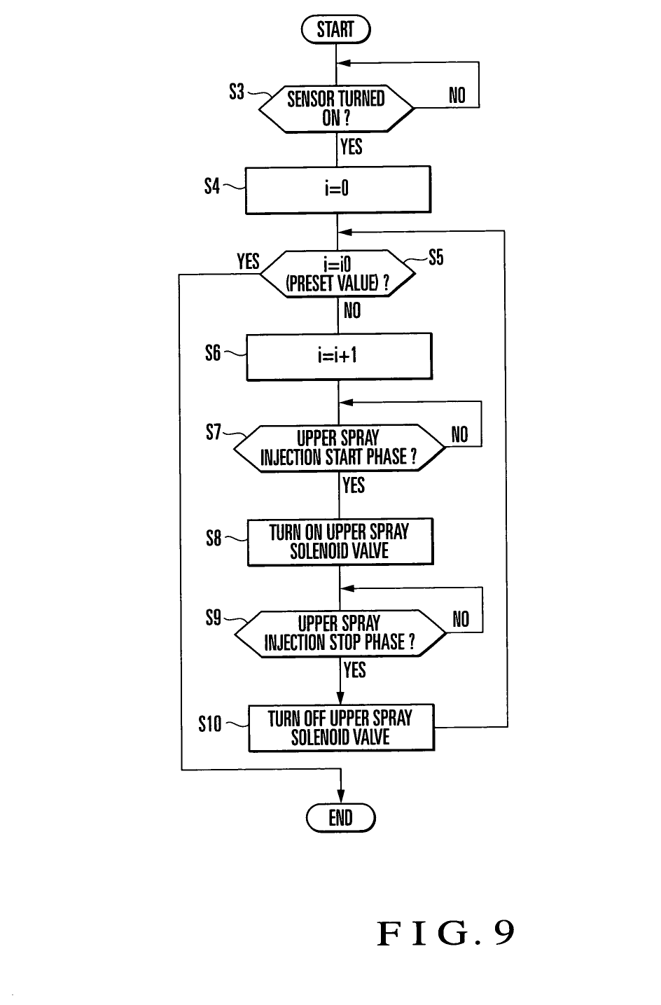

The controller 71 then actuates the upper sprays 52A of the first viscosity reducing agent supply device 50A (step S2). FIG. 9 shows step S2 in detail. First, if the sensor 55 which detects the presence/absence of the sheet on the feeder board 15 is not turned on, that is, if the sheet has not arrived at a predetermined position on the feeder board 15, the process waits its arrival (NO in step S3). If the sensor 55 is turned on (YES in step S3), that is, if the sheet has arrived at the predetermined position on the feeder board 15 and the sensor 55 detects this sheet, the injection frequency “i” of the upper sprays 52A is set to satisfy i=0 (step S4).

If “i” is not equal to the value “i0” set by the spray frequency setter 64 (NO in step S5), “i” is incremented by “1” (step S6). If the phase detected by the rotary encoder 57 is not the upper spray injection start phase (NO in step S7), that is, if the injection range of the upper sprays 52A includes the notch 21a of the upper plate cylinder 21, the process waits until the phase of the upper plate cylinder 21 falls outside the injection range.

If the phase detected by the rotary encoder 57 is the upper spray injection start phase (YES in step S7), that is, if the notch 21a of the upper plate cylinder 21 passes the injection range of the upper sprays 52A and the injection range of the upper sprays 52A starts to include the effective surface of the upper plate cylinder 21, the upper spray solenoid valve 67A is turned on. Thus, the upper sprays 52A blow the atomized varnish viscosity reducing agent 53 uniformly to the entire circumferential surface of the upper plate cylinder 21. Then, if the detected phase is not the upper spray injection stop phase (NO in step S9), that is, if the injection range of the upper sprays 52A does not include the notch 21a of the upper plate cylinder 21, the injection operation is continued.

If the detected phase is the upper spray injection stop phase (YES in step S9), that is, if the injection range of the upper sprays 52A starts to include the phase of the notch 21a of the upper plate cylinder 21, the upper spray solenoid valve 67A is turned off (step S10). Thus, injection by the upper sprays 52A is stopped, and the process returns to step S5. If i≠i0 (NO in step S5), the operation of steps S5 to S10 described above is repeated. If i=i0 (YES in step 5S), supply of the varnish viscosity reducing agent 53 from the upper sprays 52A is ended. Thus, the varnish viscosity reducing agent 53 will not be blown from the upper sprays 52A into the notch 21a of the upper plate cylinder 21.

### [Lower Spray Control (Pre-Coating)]

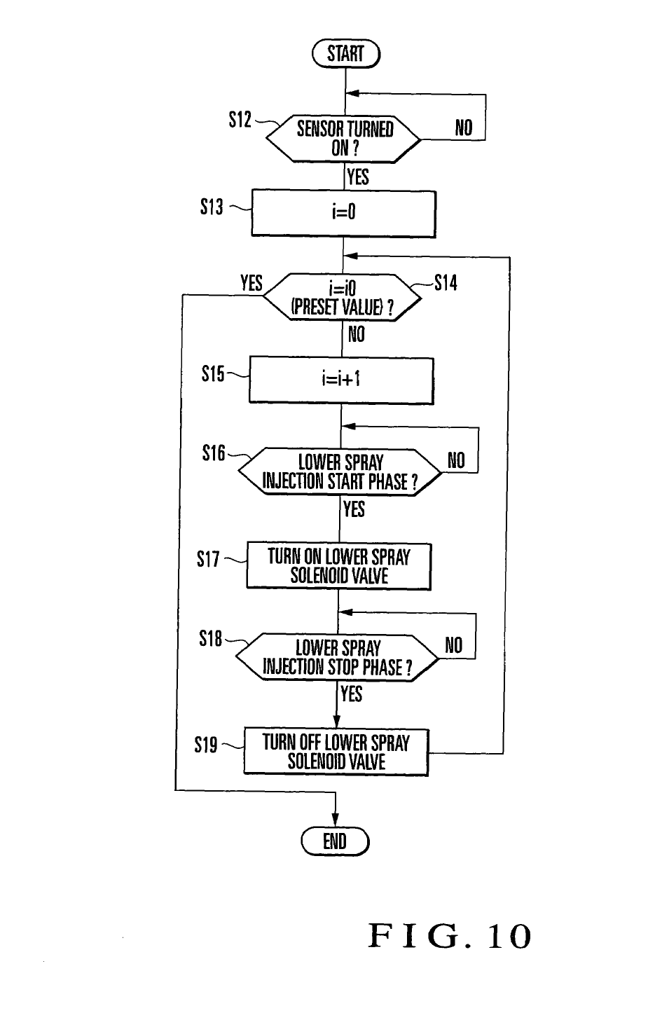

Referring back to FIG. 8, as well as the lower sprays 52B of the second viscosity reducing agent supply device 50B, the controller 71 also actuates the upper sprays 52A of the first viscosity reducing agent supply device 50A simultaneously (step S11). FIG. 10 shows step S11 in detail. First, if the sensor 55 which detects the presence/absence of the sheet on the feeder board 15 is not turned on, that is, if the sheet has not arrived at the predetermined position on the feeder board 15, the process waits its arrival (step S12). If the sensor 55 is turned on (YES in step S12), that is, if the sheet has arrived at the predetermined position on the feeder board 15 and the sensor 55 detects this sheet, the injection frequency “i” of the lower sprays 52B is set to satisfy i=0 (step S13).

If “i” is not equal to the value “i0” set by the spray frequency setter 64 (NO in step S14), “i” is incremented by “1”. If the phase detected by the rotary encoder 57 is not the lower spray injection start phase (NO in step S16), that is, if the injection range of the lower sprays 52B includes the notch 26a of the blanket cylinder 26, the process waits until the phase of the notch 26a falls outside the injection range.

If the phase detected by the rotary encoder 57 is the lower spray injection start phase (YES in step S16), that is, if the notch 26a of the blanket cylinder 26 passes the injection range of the lower sprays 52B and the injection range of the lower sprays 52B starts to include the effective surface of the blanket cylinder 26, the lower spray solenoid valve 67B is turned on (step S17). Thus, the lower sprays 52B blow the atomized varnish viscosity reducing agent 53 to the circumferential surface of the blanket cylinder 26. Then, if the detected phase is not the lower spray injection stop phase (NO in step S18), that is, if the injection range of the lower sprays 52B does not include the notch 26a of the blanket cylinder 26, the injection operation is continued.

If the detected phase is the lower spray stop phase (YES in step S18), that is, if the injection range of the lower sprays 52B starts to include the phase of the notch 26a of the blanket cylinder 26, the lower spray solenoid valve 67B is turned off (step S19). Thus, injection by the lower sprays 52B is stopped, and the process returns to step S14. If i≠i0 (NO in step S14), the operation of steps S14 to S19 is repeated. If i=0 (YES in step S14), supply of the varnish viscosity reducing agent 53 from the lower sprays 52B is ended. Thus, the varnish viscosity reducing agent 53 will not be blown from the lower sprays 52B into the notch 26a of the blanket cylinder 26.

### [Impression Throw-On]

Referring back to FIG. 8, when the process of steps S2 and S11 is ended, the controller 71 performs impression throw-on (step S20). FIG. 10 shows step S20 in detail. First, if the lower anilox roller 30 is not in the contact phase with respect to the lower plate cylinder 28 (NO in step S21), that is, if the lower anilox roller 30 does not oppose the notch 28a of the lower plate cylinder 28, the process waits until the lower anilox roller 30 does. If the lower anilox roller 30 is in the contact phase (YES in step S21), that is, if the lower anilox roller 30 opposes the notch 28a of the lower plate cylinder 28, the lower anilox roller throw-on/off mechanism 45B is turned on (step S22). Thus, the lower anilox roller 30 comes into contact with the lower plate cylinder 28.

If the lower plate cylinder 28 is not in the impression throw-on phase with respect to the lower plate cylinder 28 (NO in step S23), that is, if the notch 28a of the lower plate cylinder 28 does not oppose the notch 26a of the blanket cylinder 26, the process waits until the notch 28a does. If the lower plate cylinder 28 is in the impression throw-on phase with respect to the blanket cylinder 26 (YES in step S23), that is, if the notch 28a of the lower plate cylinder 28 opposes the notch 26a of the blanket cylinder 26, the lower plate cylinder throw-on/off mechanism 33B is actuated (step S24). Thus, the lower plate cylinder 28 comes into contact with the blanket cylinder 26, thus performing impression throw-on.

Then, if the upper anilox roller 23 is not in the contact phase with respect to the upper plate cylinder 21 (NO in step S25), that is, if the upper anilox roller 23 does not oppose the notch 21a of the upper plate cylinder 21, the process waits until the upper anilox roller 23 does. If the upper anilox roller 23 is in the contact phase with respect to the upper plate cylinder 21 (YES in step S25), that is, if the upper anilox roller 23 opposes the notch 21a of the upper plate cylinder 21, the upper anilox roller throw-on/off mechanism 45A is turned on (step S26). Thus, the upper anilox roller 23 comes into contact with the upper plate cylinder 21.

If the upper blanket cylinder 25 is not in the impression throw-on phase with respect to the upper plate cylinder 21 and blanket cylinder 26 (NO in step S27), that is, if the notch 25a of the upper blanket cylinder 25 opposes neither the notch 21a of the upper plate cylinder 21 nor the notch 26a of the blanket cylinder 26, the process waits until the notch 25a does. If the upper blanket cylinder 25 is in the impression throw-on phase with respect to the upper plate cylinder 21 and blanket cylinder 26 (YES in step S27), that is, if the notch 25a of the upper blanket cylinder 25 opposes the notch 21a of the upper plate cylinder 21 and thereafter the notch 25a of the upper blanket cylinder 25 opposes the notch 26a of the blanket cylinder 26, the upper blanket cylinder throw-on/off mechanism 33A is actuated (step S28). Thus, the upper blanket cylinder 25 moves in a direction to be close to the upper plate cylinder 21 and blanket cylinder 26. With this arrangement, the upper blanket cylinder 25 is thrown on the upper plate cylinder 21, and then thrown on the blanket cylinder 26. As the result, the upper blanket cylinder 25 comes into contact with the upper plate cylinder 21 and presses the sheet against the blanket cylinder 26.

Immediately after the first liquid supply device 22 starts to supply the varnish to the upper plate cylinder 21, the varnish supplied from the upper anilox roller 23 to the upper plate cylinder 21 is not sufficient and thus tends to dry. In steps S5 to S10 described above, the varnish viscosity reducing agent 53 supplied from the upper sprays 52A to the circumferential surface of the upper plate cylinder 21 prevents the varnish on the circumferential surface of the upper plate cylinder 21 from increasing in viscosity or drying. Therefore, the varnish does not increase in viscosity or dry also on the circumferential surface of the upper blanket cylinder 25 which is thrown on the upper plate cylinder 21.

In steps S14 to S19 described above, the varnish viscosity reducing agent 53 supplied from the lower sprays 52B to the circumferential surface of the blanket cylinder 26 transfers to the lower plate cylinder 28 which is thrown on the blanket cylinder 26. Hence, in the same manner as the upper blanket cylinder 25, immediately after the coating operation is started, the varnish supplied from the lower anilox roller 30 to the lower plate cylinder 28 is insufficient and thus tends to dry. In this case, the varnish viscosity reducing agent 53 transferring to the lower plate cylinder 28 prevents the varnish on the circumferential surface of the lower plate cylinder 28 from increasing in viscosity or drying. Therefore, the varnish does not increase in viscosity or dry also on the circumferential surface of the blanket cylinder 26 which is in contact with the lower plate cylinder 28.

After sheet feed starts in step S1, impression throw-on takes place in step S20 immediately before the cylinders are coated by the coating unit 4. During impression throw-on, the varnish on the circumferential surfaces of the upper blanket cylinder 25 and blanket cylinder 26 does not increase in viscosity or dry, as described above. Thus, the two surfaces of the paper passing between the upper blanket cylinder 25 and blanket cylinder 26 are coated without sticking to the circumferential surfaces of the two cylinders 25 and 26.

Referring back to FIG. 8, the controller 71 compares the coating sheet count set by the coating sheet count setter 68 with that counted by the counter 70 (step S29). If they are different (NO in step S29), the controller 71 performs upper spray control and lower spray control to be described below.

### [Upper Spray Control (During Coating)]

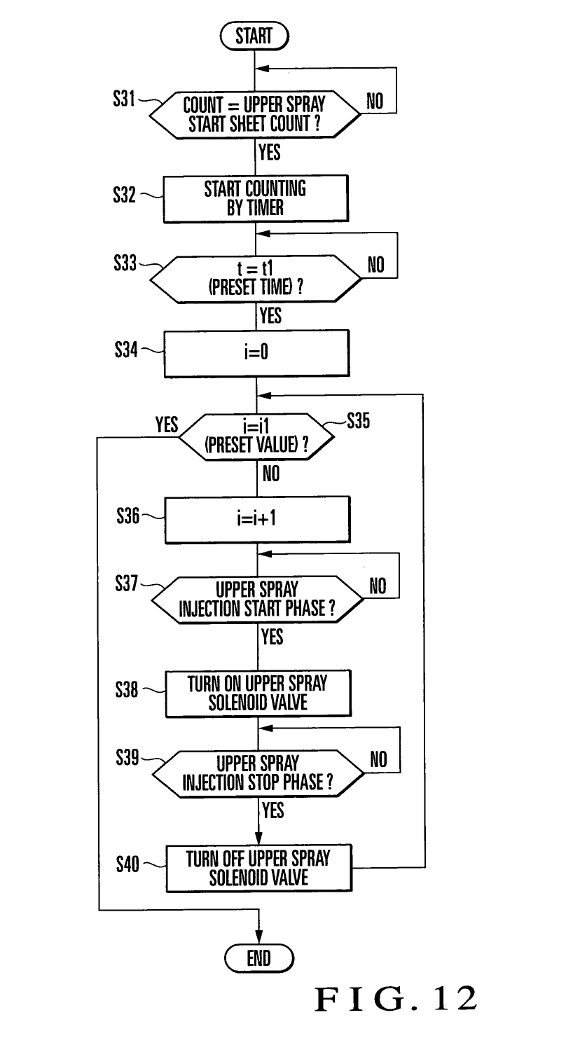

The controller 71 controls the upper sprays 52A of the first viscosity reducing agent supply device 50A during coating (step S30). FIG. 12 shows step S30 in detail. If the number of coated sheets counted by the counter 70 has not reached the value preset by the upper spray start sheet count setter 60 (NO in step S31), the process waits until they become equal. If the number of coated sheets counted by the counter 70 has reached the value preset by the upper spray start sheet count setter 60 (YES in step S31), the timer starts counting (step S32).

If the time counted by the timer has not reached a time t1 preset by the upper spray interval setter 59 (NO in step S33), the process waits until the time counted by the timer reaches the preset time t1. If the time counted by the timer has reached the preset time t1 (YES in step S33), the injection frequency “i” of the upper sprays 52A is set to satisfy i=0 (step S34).

If the injection frequency “i” is not equal to a value “i1” preset by the upper spray frequency setter 58 (NO in step S35), “i” is incremented by “1” (step S36). If the phase detected by the rotary encoder 57 is not the upper spray injection start phase, that is, if the injection range of the upper sprays 52A includes the notch 21a of the upper plate cylinder 21 (NO in step S37), the process waits until the notch 21a falls outside the injection range.

If the rotary encoder 57 detects the upper spray injection start phase (YES in step S37), that is, if the notch 21a of the upper plate cylinder 21 passes the injection range of the upper sprays 52A and falls outside that injection range, the upper spray solenoid valve 67A is turned on (step S38). Thus, the upper sprays 52A blow the atomized varnish viscosity reducing agent 53 uniformly to the entire circumferential surface of the upper plate cylinder 21. Then, if the phase detected by the rotary encoder 57 is not the upper spray injection stop phase, that is, if the notch 21a of the upper plate cylinder 21 falls outside the injection range of the upper sprays 52A (NO in step S39), the injection operation is continued.

If the rotary encoder 57 detects the upper spray injection stop phase, that is, if the notch 21a of the upper plate cylinder 21 falls within the injection range of the upper sprays 52A, the upper spray solenoid valve 67A is turned off (step S40). Thus, injection of the varnish viscosity reducing agent 53 by the upper sprays 52A is stopped, and the process returns to step S35. If i≠i1 (NO in step S35), the operation of steps S35 to S40 is repeated. If i=i1 (YES in step S35), the supply operation of the varnish viscosity reducing agent 53 from the upper sprays 52A is ended. As described above, since the injection operation of the varnish viscosity reducing agent 53 is stopped when the upper sprays 52A oppose the notch 21a of the upper plate cylinder 21, the varnish viscosity reducing agent 53 will not be blown from the upper sprays 52A into the notch 21a.

Referring back to FIG. 8, if the number of coated sheets counted by the counter 70 is different from that set by the coating sheet count setter 68 (NO in step S29), that is, during the coating operation, the controller 71 repeats the control of the upper sprays 52A shown in step S30. That is, the injection operation of the upper sprays 52A is performed the number of times equal to that set by the upper spray frequency setter 58. Then, at the intervals set by the upper spray interval setter 59, the controller 71 repeats the injection operation of the upper sprays 52A a plurality of number of times until the number of coated sheets counted by the counter 70 reaches that set by the coating sheet count setter 68.

In this embodiment, the injection interval of the upper sprays 52A is set by the upper spray interval setter 59. However, the present invention is not limited to this, and the upper spray start sheet count setter 60 may set a plurality of upper spray start sheet counts so that the injection operation of the upper sprays 52A is performed at predetermined intervals based on the plurality of upper spray start sheet counts. In this case, the upper spray interval setter 59 is unnecessary.

If the number of coated sheets counted by the counter 70 is equal to that set by the coating sheet count setter 68 (step S29), the process advances to step S52.

### [Lower Spray Control (During Coating)]

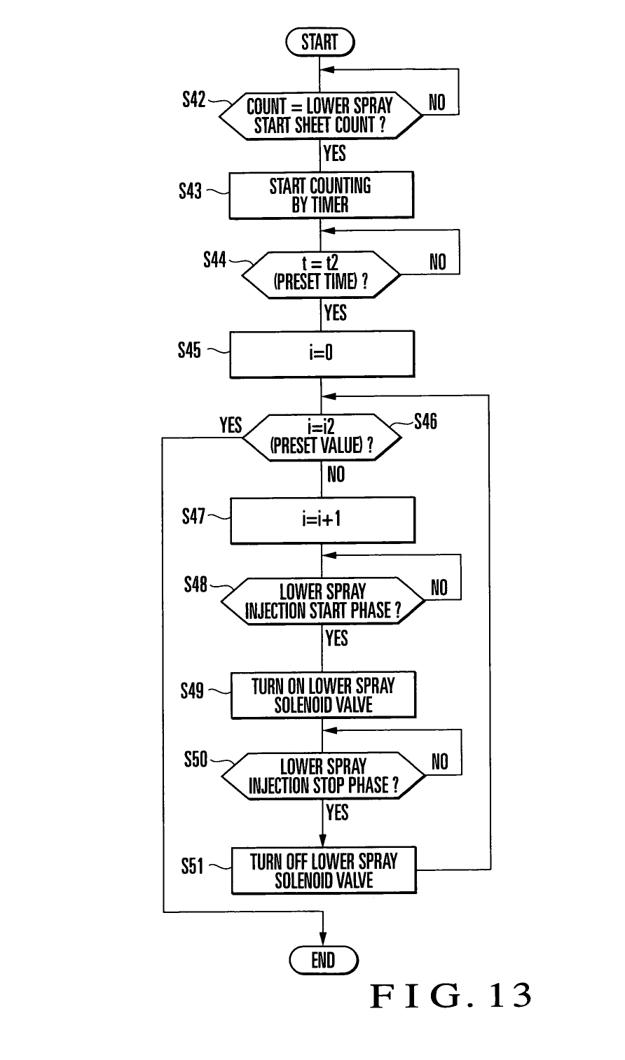

As shown in FIG. 8, during the coating, lower spray control is performed almost at the same time as the upper spray control (step S30). The controller 71 controls the lower sprays 52B of the second viscosity reducing agent supply device 50B during the coating (step S41). FIG. 13 shows step S41 in detail. If the number of coated sheets counted by the counter 70 has not reached the value preset by the lower spray start sheet count setter 63 (NO in step S42), the process waits until they become equal. If the number of coated sheets counted by the counter 70 has reached the value preset by the lower spray start sheet count setter 63 (YES in step S42), the timer starts counting (step S43).

If the time counted by the timer has not reached a time t2 preset by the lower spray interval setter 62 (NO in step S44), the process waits until the time counted by the timer reaches the preset time t2. If the time counted by the timer has reached the preset time t2 (YES in step S44), the injection frequency “i” of the lower sprays 52B is set to satisfy i=0 (step S45).

If the injection frequency “i” is not equal to a value “i2” preset by the lower spray frequency setter 61 (NO in step S46), “i” is incremented by “1” (step S47). If the phase detected by the rotary encoder 57 is not the lower spray injection start phase, that is, if the notch 26a of the blanket cylinder 26 falls within the injection range of the lower sprays 52B (NO in step S48), the process waits until the notch 26a falls outside the injection range.

If the rotary encoder 57 detects the lower spray injection start phase (YES in step S48), that is, if the notch 26a of the blanket cylinder 26 passes the injection range of the lower sprays 52B and falls outside that injection range, the lower spray solenoid valve 67B is turned on (step S49). Thus, the lower sprays 52B blow the atomized varnish viscosity reducing agent 53 uniformly to the entire circumferential surface of the blanket cylinder 26. Then, if the phase detected by the rotary encoder 57 is not the lower spray injection stop phase, that is, if the notch 26a of the blanket cylinder 26 falls outside the injection range of the lower sprays 52B (NO in step S50), the injection operation is continued.

If the rotary encoder 57 detects the lower spray injection stop phase, that is, if the notch 26a of the blanket cylinder 26 falls within the injection range of the lower sprays 52B, the lower spray solenoid valve 67B is turned off (step S51). Thus, injection of the varnish viscosity reducing agent 53 by the lower sprays 52B is stopped, and the process returns to step S46. If i≠i2 (NO in step S46), the operation of steps S46 to S51 is repeated. If i=i2 (YES in step S46), the supply operation of the varnish viscosity reducing agent 53 from the lower sprays 52B is ended.

As described above, since the injection operation of the varnish viscosity reducing agent 53 is stopped when the lower sprays 52B oppose the notch 26a of the blanket cylinder 26, the varnish viscosity reducing agent 53 will not be blown from the lower sprays 52B into the notch 26a.

Referring back to FIG. 8, if the number of coated sheets counted by the counter 70 is different from that set by the coating sheet count setter 68 (NO in step S29), that is, during the coating operation, the controller 71 repeats the control of the lower sprays 52B shown in step S41. That is, the injection operation of the lower sprays 52B is performed the number of times equal to that set by the lower spray frequency setter 61. Then, at the intervals set by the lower spray interval setter 62, the controller 71 repeats the injection operation of the lower sprays 52B a plurality of number of times until the number of coated sheets counted by the counter 70 reaches that set by the coating sheet count setter 68.

In this embodiment, the injection interval of the lower sprays 52B is set by the lower spray interval setter 62. However, the present invention is not limited to this, and the lower spray start sheet count setter 63 may set a plurality of lower spray start sheet counts so that the injection operation of the lower sprays 52B is performed at predetermined intervals based on the plurality of lower spray start sheet counts. In this case, the lower spray interval setter 62 is unnecessary.

If the number of coated sheets counted by the counter 70 becomes equal to that set by the coating sheet count setter 68 (step S29), the process advances to step S61.

As has been described above, the varnish viscosity reducing agent 53 is supplied to the circumferential surface of the upper plate cylinder 21 and that of the blanket cylinder 26, during the coating operation as well. Therefore, even if the viscosity of varnish transferred to the circumferential surface of the upper blanket cylinder 25 and/or that of the blanket cylinder 26 increases during the coating operation as the time passes, the viscosity can be reduced with the varnish viscosity reducing agent 53. In addition, the varnish viscosity reducing agent 53 can prevent the accumulation of varnish or ink on the circumferential surface of the upper blanket cylinder 25 and that of the blanket cylinder 26. Accordingly, a sheet will not stick to the circumferential surfaces of the cylinders 25 and 26, and therefore the operation of removing the sheet from the circumferential surfaces of the cylinders 25 and 26 becomes unnecessary, reducing the work load to the operator and improving the productivity.

Furthermore, nonuniformity in the varnish transferred to the reverse of the sheet, which occurs when the leading edge portion of the sheet is pulled up by the upper blanket cylinder 25, will not occur. Accordingly, the coating quality can improve. In addition, since the upper sprays 52A and lower sprays 52B inject the varnish viscosity reducing agent 53 to the circumferential surface of the upper plate cylinder 21 and that of the blanket cylinder 26, respectively, the viscosity of varnish supplied to the respective circumferential surfaces of the upper plate cylinder 21 and blanket cylinder 26 can be reliably reduced.

### [Upper Spray Control (Post-Coating)]

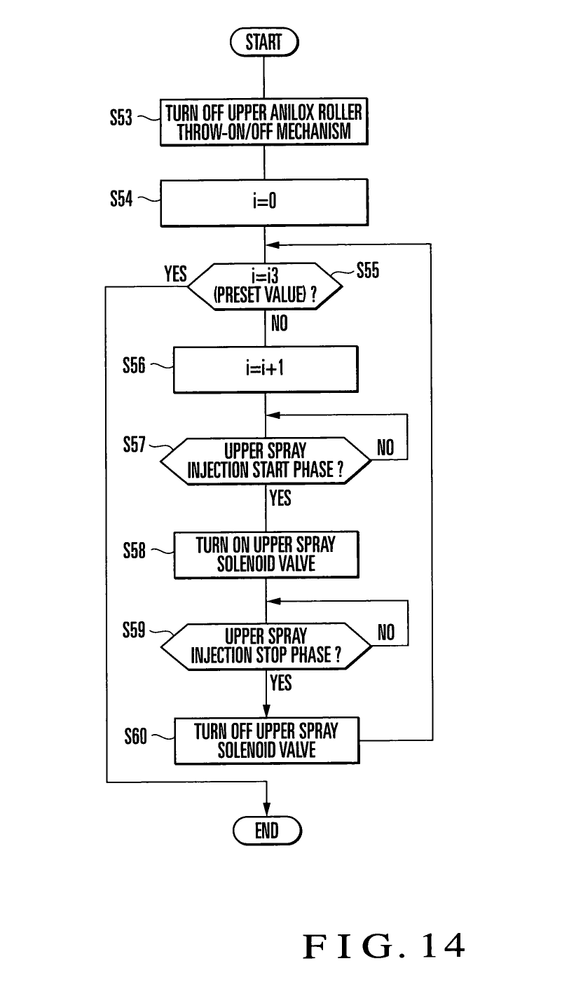

The controller 71 controls the upper sprays 52A of the first viscosity reducing agent supply device 50A after the coating (step S52). FIG. 14 shows step S52 in detail. The upper anilox roller throw-on/off mechanism 45A is turned off (step S53), and the upper anilox roller 23 separates from the upper plate cylinder 21. The injection frequency “i” of the upper sprays 52A is set to satisfy i=0 (step S54).

If the injection frequency “i” is not equal to the value “i3” preset by the post-coating spray frequency setter 65 (NO in step S55), “i” is incremented by “1” (step S56). If the phase detected by the rotary encoder 57 is not the upper spray injection start phase, that is, if the notch 21a of the upper plate cylinder 21 falls within the injection range of the upper sprays 52A (NO in step S57), the process waits until the notch 21a falls outside the injection range.

If the phase detected by the rotary encoder 57 is the upper spray injection start phase, that is, if the notch 21a of the upper plate cylinder 21 passes the injection range of the upper sprays 52A and falls outside that injection range, the upper spray solenoid valve 67A is turned on (step S58). Thus, the upper sprays 52A blow the atomized varnish viscosity reducing agent 53 uniformly to the entire circumferential surface of the upper plate cylinder 21. Then, if the phase detected by the rotary encoder 57 is not the upper spray injection stop phase, that is, if the notch 21a of the upper plate cylinder 21 falls outside the injection range of the upper sprays 52A (NO in step S59), the injection operation is continued.

If the phase detected by the rotary encoder 57 is the upper spray injection stop phase, that is, if the notch 21a of the upper plate cylinder 21 falls within the injection range of the upper sprays 52A, the upper spray solenoid valve 67A is turned off (step S60). Thus, the injection operation of the upper sprays 52A is stopped, and the process returns to step S55. If i≠i3 (NO in step S55), the operation of steps S55 to S60 is repeated. If i=i3 (YES in step S55), the supply operation of the varnish viscosity reducing agent 53 from the upper sprays 52A is ended.

As described above, since the injection operation of the varnish viscosity reducing agent 53 is stopped when the upper sprays 52A oppose the notch 21a of the upper plate cylinder 21, the varnish viscosity reducing agent 53 will not be blown from the upper sprays 52A into the notch 21a.

### [Lower Spray Control (Post-Coating)]

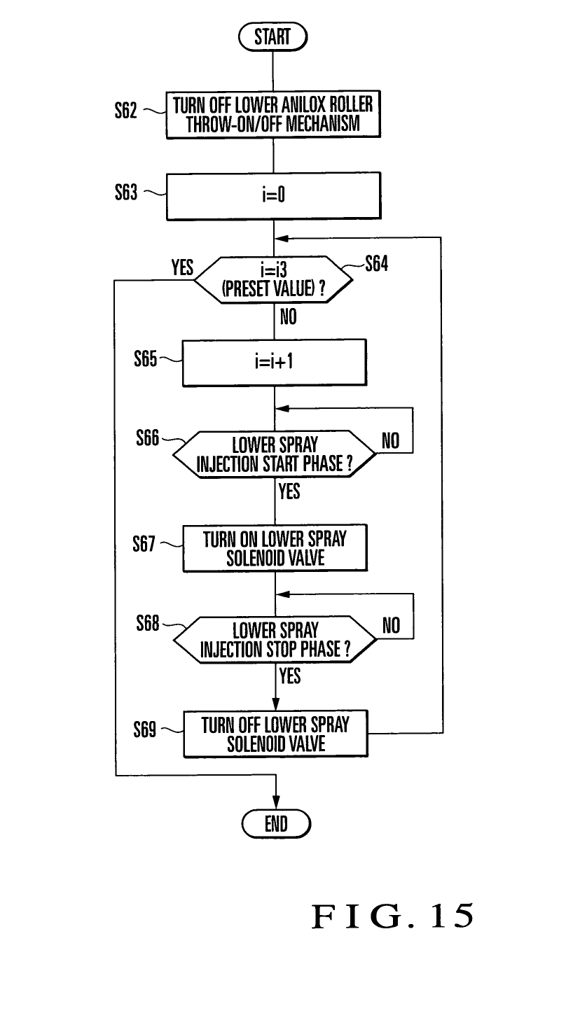

As shown in FIG. 8, lower spray control is performed almost at the same time as the upper spray control (step S52) after the coating. The controller 71 controls the lower sprays 52B of the second viscosity reducing agent supply device 50B after the coating (step S61). FIG. 15 shows step S61 in detail. The lower anilox roller throw-on/off mechanism 45B is turned off (step S62), and the lower anilox roller 30 separates from the lower plate cylinder 28. The injection frequency “i” of the lower sprays 52B is set to satisfy i=0 (step S63).

If the injection frequency “i” is not equal to the value “i3” preset by the post-coating spray frequency setter 65 (NO in step S64), “i” is incremented by “1” (step S65). If the phase detected by the rotary encoder 57 is not the lower spray injection start phase, that is, if the notch 26a of the blanket cylinder 26 falls within the injection range of the lower sprays 52B (NO in step S66), the process waits until the notch 21a falls outside the injection range.

If the phase detected by the rotary encoder 57 is the lower spray injection start phase, that is, if the notch 26a of the blanket cylinder 26 passes the injection range of the lower sprays 52B and falls outside that injection range, the lower spray solenoid valve 67B is turned on (step S67). Thus, the lower sprays 52B blow the atomized varnish viscosity reducing agent 53 uniformly to the entire circumferential surface of the blanket cylinder 26. Then, if the phase detected by the rotary encoder 57 is not the lower spray injection stop phase, that is, if the notch 21a of the blanket cylinder 26 falls outside the injection range of the lower sprays 52B (NO in step S68), the injection operation is continued.

If the phase detected by the rotary encoder 57 is the lower spray injection stop phase, that is, if the notch 26a of the blanket cylinder 26 falls within the injection range of the lower sprays 52B, the lower spray solenoid valve 67B is turned off (step S69). Thus, the injection operation of the lower sprays 52B is stopped, and the process returns to step S64. If i≠i3 (NO in step S64), the operation of steps S64 to S69 is repeated. If i=i3 (YES in step S64), the supply operation of the varnish viscosity reducing agent 53 from the lower sprays 52B is ended.

As described above, since the injection operation of the varnish viscosity reducing agent 53 is stopped when the lower sprays 52B oppose the notch 26a of the blanket cylinder 26, the varnish viscosity reducing agent 53 will not be blown from the lower sprays 52B into the notch 26a.

Referring back to FIG. 8, if the number of coated sheets counted by the counter 70 is different from the value preset by the cleaning-by-printing sheet count setter 69 (NO in step S70), the process waits until they become equal. If the number of coated sheets counted by the counter 70 is equal to the value preset by the cleaning-by-printing sheet count setter 69 (YES in step S70), the controller 71 stops sheet feed from the feeder 2 (step S71).

In this manner, since the varnish viscosity reducing agent 53 is supplied to the blanket cylinder 26 and upper blanket cylinder 25, to which the varnish has been supplied, before a cleaning-by-printing sheet is conveyed to the position where the blanket cylinder 26 opposes the upper blanket cylinder 25, the varnish whose viscosity has been reduced with the varnish viscosity reducing agent 53 is transferred to the cleaning-by-printing sheet. Thus, almost all the varnish attached to the respective circumferential surfaces of the upper plate cylinder 21, upper blanket cylinder 25, blanket cylinder 26, and lower plate cylinder 28 can be removed.

### [Impression Throw-Off]

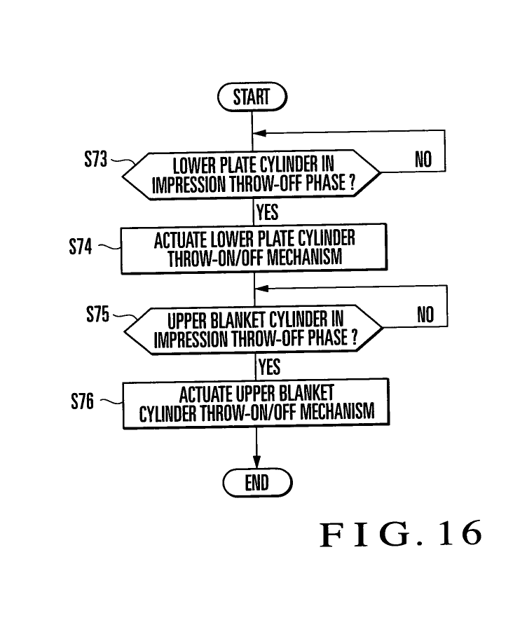

Referring back to FIG. 8, the controller 71 performs impression throw-off after stopping the sheet feed (step S72). FIG. 16 shows step S72 in detail. First, if the lower plate cylinder 28 is not in the impression throw-off phase with respect to the blanket cylinder 26, that is, if the notch 28a of the lower plate cylinder 28 does not oppose the notch 26a of the blanket cylinder 26 (NO in step S73), the process waits until the notch 28a does. If the lower plate cylinder 28 is in the impression throw-off phase with respect to the blanket cylinder 26, that is, if the notch 28a of the lower plate cylinder 28 opposes the notch 26a of the blanket cylinder 26, the lower plate cylinder throw-on/off mechanism 33B is turned off, and the lower plate cylinder 28 separates from the blanket cylinder 26, thus performing impression throw-off (step S74).

Then, if the upper blanket cylinder 25 is not in the impression throw-off phase with respect to the upper plate cylinder 21 and blanket cylinder 26, that is, if the notch 25a of the upper blanket cylinder 25 does not oppose the notch 21a of the upper plate cylinder 21 and the notch 26a of the blanket cylinder 26 (NO in step S75), the process waits until the notch 25a does. If the upper blanket cylinder 25 is in the impression throw-off phase with respect to the upper plate cylinder 21 and blanket cylinder 26, that is, if the notch 25a of the upper blanket cylinder 25 opposes the notch 26a of the blanket cylinder 26 and then opposes the notch 21a of the upper plate cylinder 21, the upper blanket cylinder throw-on/off mechanism 33A is turned off (step S76). With this arrangement, the upper blanket cylinder 25 is thrown off the blanket cylinder 26, and then thrown off the upper plate cylinder 21.

In this embodiment, the second viscosity reducing agent supply device 50B supplies the varnish viscosity reducing agent 53 to the blanket cylinder 26 directly. Alternatively, the varnish viscosity reducing agent 53 may be supplied to the lower plate cylinder 28, so it is supplied indirectly through the lower plate cylinder 28. This embodiment also exemplified a case in which the present invention is applied to a coating apparatus. Alternatively, the present invention may be applied to a printing apparatus which prints a sheet with ink. In this case, as the ink supply device, a chamber type inking device which supplies ink having a comparatively high viscosity from a chamber coater 24 or 31, or an inking device which has an ink fountain and a large number of rollers may be employed.

The target to which the varnish or ink is to be transferred is exemplified by a sheet. Alternatively, the target may be a web. Although water is used as the varnish viscosity reducing agent 53, another liquid for reducing the viscosity of the varnish may be employed. The varnish viscosity reducing agent 53 need not be liquid but may be powder. The varnish viscosity reducing agent 53 is injected to the circumferential surface of the upper plate cylinder 21 and that of the blanket cylinder 26 by the upper sprays 52A and lower sprays 52B, respectively. Alternatively, the varnish viscosity reducing agent 53 may be supplied to one of the upper plate cylinder 21 and blanket cylinder 26.

As has been described above, according to the present invention, even when the viscosity of varnish/ink increases during coating/printing, it is possible to reduce the viscosity of the varnish/ink and prevent the accumulation of the varnish/ink on the surface of the supply cylinder as well. Accordingly, a sheet/web will not stick to the supply cylinder. Therefore, the operation of removing the sheet/web from the supply cylinder becomes unnecessary, thus reducing the work load to the operator and improving the productivity.

When coating/printing the two surfaces of a sheet, it is prevented that the leading edge portion of the sheet adheres to the supply cylinder so that it is pulled up. Accordingly, nonuniformity in varnish/ink transferred to the reverse of the sheet will not occur. Therefore, the coating/printing quality can improve.

What is claimed is:

1. A liquid transfer apparatus comprising:
a supply cylinder which comes into contact with a transfer target body and performs transfer by transferring a transfer liquid to the transfer target body; and
viscosity reducing agent supply means for supplying a viscosity reducing agent which reduces a viscosity of the transfer liquid to said supply cylinder during transfer.

2. An apparatus according to claim 1, further comprising control means for controlling operation of said viscosity reducing agent supply means of supplying the viscosity reducing agent to said supply cylinder.

3. An apparatus according to claim 2, wherein when continuously performing transfer with the transfer liquid transferred from said supply cylinder, said control means controls said viscosity reducing agent supply means to supply the viscosity reducing agent to the transfer liquid on said supply cylinder before performing first transfer.

4. An apparatus according to claim 2, further comprising liquid supply means for supplying the transfer liquid to said supply cylinder,
wherein said control means controls said viscosity reducing agent supply means so as to supply the viscosity reducing agent to the transfer liquid on said supply cylinder after said liquid supply means last supplies the transfer liquid and before an operation of transferring to the transfer target body is ended.

5. An apparatus according to claim 2, wherein said control means controls said viscosity reducing agent supply means so as to supply the viscosity reducing agent to said supply cylinder at a predetermined interval.

6. An apparatus according to claim 5, further comprising supply interval setting means for setting a supply interval of the viscosity reducing agent,
wherein said viscosity reducing agent supply means supplies the viscosity reducing agent to said supply cylinder on the basis of the supply interval set by said supply interval setting means.

7. An apparatus according to claim 2, further comprising supply start timing setting means for setting a supply start timing of the viscosity reducing agent,
wherein said control means controls said viscosity reducing agent supply means so as to supply the viscosity reducing agent to said supply cylinder on the basis of the supply start timing set by said supply start timing setting means.

8. An apparatus according to claim 2, wherein
said supply cylinder includes a notch, and
said control means controls said viscosity reducing agent supply means so as to supply the viscosity reducing agent to a circumferential surface of said supply cylinder excluding said notch.

9. An apparatus according to claim 8, further comprising phase detection means for detecting a phase of said apparatus,
wherein said control means controls said viscosity reducing agent supply means so as to supply the viscosity reducing agent to the circumferential surface of said supply cylinder excluding said notch, on the basis of the phase of said apparatus detected by said phase detection means.

10. An apparatus according to claim 1, further comprising
first liquid supply means for supplying the transfer liquid to a first cylinder,
a second cylinder, serving as said supply cylinder, which performs transfer to one surface of the transfer target body with the transfer liquid transferred from said first cylinder,
a third cylinder, serving as said supply cylinder, which is arranged to oppose said second cylinder and performs transfer to the other surface of the transfer target body, and
second liquid supply means for supplying the transfer liquid to said third cylinder,
wherein said viscosity reducing agent supply means supplies the viscosity reducing agent to at least one of said first cylinder and said third cylinder.

11. An apparatus according to claim 10, wherein said viscosity reducing agent supply means comprises
a first viscosity reducing agent supply device which supplies the viscosity reducing agent to said first cylinder, and
a second viscosity reducing agent supply device which supplies the viscosity reducing agent to said third cylinder.
